(19) United States
(12) Patent Application Publication
(10) Pub. No.: US 2023/0035995 A1
(43) Pub. Date: Feb. 2, 2023

(54) METHOD, APPARATUS AND STORAGE MEDIUM FOR OBJECT ATTRIBUTE CLASSIFICATION MODEL TRAINING

(71) Applicant: LEMON INC., Grand Cayman (KY)

(72) Inventors: Jingna SUN, Beijing (CN); Weihong ZENG, Beijing (CN); Peibin CHEN, Beijing (CN); Xu WANG, Beijing (CN); Shen SANG, Los Angeles, CA (US); Jing LIU, Los Angeles, CA (US); Chunpong LAI, Los Angeles, CA (US)

(21) Appl. No.: 17/534,222

(22) Filed: Nov. 23, 2021

(30) Foreign Application Priority Data
Jul. 29, 2021 (CN) 202110863527.7

(51) Int. Cl. G06N 3/08

(52) U.S. Cl. CPC G06N 3/08

(57) ABSTRACT

The present disclosure relates to method, apparatus and storage medium for object attribute classification model training. There proposes a method of training a model for object attribute classification, comprising steps of: acquiring binary class attribute data related to a to-be-classified attribute on which an attribute classification task is to be performed, wherein the binary class attribute data includes data indicating whether the to-be-classified attribute is “Yes” or “No” for each of at least one class label; and pre-training the model for object attribute classification based on the binary class attribute data.

### CROSS-REFERENCE TO RELATED APPLICATIONS

The present disclosure is based on and claims priority to China Patent Application No. 202110863527.7 filed on Jul. 29, 2021, the disclosure of which is incorporated by reference herein in its entirety.

### FIELD OF THE INVENTION

The present disclosure relates to object recognition, and in particular to object attribute classification.

### BACKGROUND

In recent years, object detection/recognition/comparison/tracking for static images or a series of moving images (such as video) has been widely and importantly applied in fields of image processing, computer vision and recognition, such as a variety of fields comprising Web image automatic annotation, mass image search, image content filtering, robotics, security monitoring, medical remote consultation and so on, and plays an important role therein. An object can be a person, a body part of a person, such as a face, hands, body, etc., other creatures or plants, or any other object desired to be detected. Object recognition/verification is one of the most important computer vision tasks, and its goal is to accurately identify or verify a specific object in input photos/videos. Human body part recognition, especially face recognition, is widely used currently, and a face image often contains a lot of attribute information, including information on eye shape, eyebrow shape, nose shape, face shape, hairstyle, beard type and so on. Classification of face attributes will facilitate clearer understanding of a portrait.

### DISCLOSURE OF THE INVENTION

This section is provided to introduce the inventive concepts in a brief form, which will be described in the following detailed description section in detail. This summary is not intended to identify key features or essential features of the claimed technical solution, nor intended to limit the scope of the claimed technical solution.

According to some embodiments of the present disclosure, there is provided a method of training a model for object attribute classification, which comprises steps of: acquiring binary class attribute data related to a to-be-classified attribute on which a classification task is to be performed, wherein the binary class attribute data includes data indicating whether the to-be-classified attribute is “Yes” or “No” for each of at least one class label; and pre-training the model for object attribute classification based on the binary class attribute data.

According to other embodiments of the present disclosure, there is provided an apparatus of training a model for object attribute classification, comprising a binary class attribute data acquisition unit configured to acquire binary class attribute data related to a to-be-classified attribute on which a classification task is to be performed, wherein the binary class attribute data includes data indicating whether the to-be-classified attribute is “Yes” or “No” for each of at least one class label; and a pre-training unit configured to pre-train the model for object attribute classification based on the binary class attribute data.

According to some embodiments of the present disclosure, there is provided an electronic device including a memory; and a processor coupled to the memory, the processor configured to execute the method of any embodiment described in the present disclosure based on instructions stored in the memory.

According to some embodiments of the present disclosure, there is provided a computer-readable storage medium having a computer program stored thereon, which when executed by a processor performs the method of any embodiment described in the present disclosure.

Other features, aspects and advantages of the present disclosure will become apparent from the following detailed description of exemplary embodiments of the present disclosure with reference to the accompanying drawings.

### DESCRIPTION OF THE DRAWINGS

Preferred embodiments of the present disclosure will be described below with reference to the accompanying drawings. The accompanying drawings, which are illustrated herein, aim to provide a further understanding of the present disclosure, are incorporated in and form a part of this specification together with the detailed description below, and serve to explain the present disclosure. It should be understood that the drawings involved in the following description only refer to some embodiments of the present disclosure, and do not constitute limitations on the present disclosure. In the drawings:

FIG. 1 shows a conceptual diagram of object attribute classification according to an embodiment of the present disclosure.

FIG. 2 shows a flowchart of a method of training a model for object attribute classification according to an embodiment of the present disclosure.

FIG. 3A shows a schematic diagram of exemplary model pre-training for face attribute classification according to an embodiment of the present disclosure, and FIG. 3B shows a schematic diagram of exemplary model training for face attribute classification according to an embodiment of the present disclosure.

FIG. 4 shows a block diagram of an apparatus of training a model for object attribute classification according to an embodiment of the present disclosure.

FIG. 5 shows a block diagram of an electronic device according to some embodiments of the present disclosure.

FIG. 6 shows a block diagram of an electronic device according to some other embodiments of the present disclosure.

It should be understood that for convenience of description, the dimensions of various parts shown in the drawings are not necessarily drawn according to the actual scale relationship. Same or similar reference numerals are used in the figures to indicate the same or similar parts. Therefore, once an item is defined in one figure, it may not be further discussed in the following figures.

### DETAILED DESCRIPTION OF PREFERRED EMBODIMENTS

The technical solution in the embodiments of this disclosure will be described in conjunction with the drawings in the embodiments of this disclosure clearly and completely, but it is obvious that the described embodiments are only part of embodiments of this disclosure, not all of them. The following description of the embodiments is merely illustrative, and in no way serves as any limitation on the present disclosure and its application or usage. It should be understood that the present disclosure may be embodied in various forms and should not be construed as being limited to the embodiments set forth herein.

It should be understood that each step recited in the method embodiments of the present disclosure can be performed in different orders and/or in parallel. In addition, a method embodiment may include additional steps and/or omit performing the illustrated steps. The scope of the present disclosure is not limited in this respect. Unless otherwise specified, the relative arrangement of components and steps, numerical expressions and numerical values set forth in these embodiments should be interpreted as merely exemplary, instead of limiting the scope of the present disclosure.

As used in this disclosure, the term “including” and its variants mean an open term that includes at least the following elements/features, but does not exclude other elements/features, that is, “including but not limited to”. In addition, the term “comprising”, and its variants as used in this disclosure means an open term that comprises at least the following elements/features, but does not exclude other elements/features, that is, “comprising but not limited to”. Therefore, “including” is synonymous with “comprising”. The term “based on” means “based at least in part on”.

“One embodiment”, “some embodiments” or “an embodiment” as recited throughout this specification mean that a particular feature, structure, or characteristic described in connection with an embodiment can be included in at least one embodiment of the present invention. For example, the term “one embodiment” means “at least one embodiment”; the term “another embodiment” means “at least one further embodiment”; the term “some embodiments” means “at least some embodiments”. Furthermore, the appearances of the phrases “in one embodiment”, “in some embodiments” or “in an embodiment” in various places throughout the specification do not necessarily all refer to the same embodiment, but may also refer to the same embodiment.

It should be noted that the concepts of “first” and “second” mentioned in this disclosure are only used to distinguish different devices, modules, or units, but not used to define the order or interdependence of functions performed by these devices, modules, or units. Unless otherwise specified, the concepts of “first”, “second” and the like are not intended to imply that the objects so described must be in a given time order, space order, ranking or any other type of given order.

It should be noted that the modifier “a” or “a plurality of” mentioned in this disclosure are illustrative and not restrictive, and those skilled in the art shall understand that it should be interpreted as “one or more”, unless explicitly stated in the context.

The name of message or information exchanged between multiple apparatuses in embodiments of the present disclosure are for illustrative purposes only, instead of being used to limit the scope of the message or information.

In image/video object recognition, an object may commonly contain multiple attributes, and classification of attributes is helpful to identify and recognize the object more accurately. Taking human face as an example, a human face can contain various attribute information, such as information on eye shape, eyebrow shape, nose shape, face shape, hairstyle, beard type and so on. Therefore, when a human face is an object to be recognized, analyzing/classifying each of the attribute information, that is, identifying/analyzing the type/style of each attribute, such as eyebrow type, eye type, etc., will contribute to the accurate identification and recognition of the human face.

Analyzing/classifying object attributes for a specific image, video, etc. is usually realized by inputting the image, video, etc. into a corresponding model for processing. The model can be obtained by training with training samples, such as pre-acquired image samples. In model training, there can also include pre-training based on image samples, and then modifying and transforming the pre-trained model for an attribute classification task, so as to obtain a model especially suitable for the attribute classification task. By using the obtained model, a desired attribute classification can be realized. FIG. 1 shows a basic diagram of an object attribute classification process, including model pre-training, model training and model application.

At present, for a face attribute classification task, taking eyebrow attribute classification as an example, in the prior art, different eyebrow data are collected and manually annotated, and then the training is carried out on the data by loading ImageNet pre-trained model. However, the ImageNet pre-trained model is usually obtained by pre-training on a general data set ImageNet, which mainly focuses on the global category classification, such as car, boat, bird, etc., rather than specific attributes of specific objects. In particular, the face attribute class does not belong to the existing class of ImageNet training model, such category classification is obviously different from that for face attributes and thus the face attributes cannot be accurately distinguished. Therefore, the ImageNet pre-trained model, when directly employed for the face attribute classification, cannot achieve good results. Another solution is to use data of corresponding attributes (eyebrow type data) for pre-training. However, in the actual scenario, there is no multi-class data set of eyebrows, so it is difficult to obtain the pre-trained model for corresponding attributes to enhance the effect of the model.

In view of this, the present disclosure proposes an improved model pre-training for object attribute classification, in which specific kinds of attribute-related data can be efficiently acquired, and the specific kinds of attribute-related data are used for model pre-training for object attribute classification, so that a pre-trained model can be efficiently and accurately obtained for object attribute classification. According to some embodiments, the specific kinds of attribute-related data can indicate the relationship between attributes and category/class labels in a low-ambiguity manner, and can be obtained efficiently and at low cost. The specific kinds of attribute-related data can be in various suitable forms, especially binary class attribute data which indicates whether the attribute is “Yes” or “No” for a certain class label. That is, the binary class attribute data indicates whether the class label of the attribute is “Yes” or “No”.

In addition, the present disclosure also proposes an improved training method for object attribute classification model, in which the model pre-training is performed as described above to obtain a pre-trained model, and then attribute class label data involved in the attribute classification task is used for further training based on the pre-trained model to obtain an improved attribute classification model.

In addition, the present disclosure also provides an improved object attribute classification method, in which more accurate and appropriate classification can be realized based on the aforementioned pre-trained model. In particular, an improved attribute classification model can be obtained based on the pre-trained model as mentioned above, and the object attribute classification can be performed based on the classification model, so as to obtain a better classification effect.

Embodiments of the present disclosure will be described in detail with reference to the accompanying drawings, but the present disclosure is not limited to these specific embodiments. The following specific embodiments can be combined with each other, and the same or similar concepts or processes may not be repeated in some embodiments. Furthermore, in one or more embodiments, specific features, structures, or characteristics may be combined in any suitable manner that will be apparent to those ordinary skill in the art from this disclosure.

It should be understood that the present disclosure does not limit how to obtain images containing object attributes to be recognized/classified. In one embodiment of the present disclosure, the images can be obtained from a storage device, such as an internal memory or an external storage device, and in another embodiment of the present disclosure, the images can be taken by utilizing a photographing component. As an example, the acquired image can be a collected image or a frame image in the collected video, and is not particularly limited to this.

In the context of the present disclosure, an image may refer to any one of a variety of images, such as a color image, a grayscale image, and the like. It should be noted that in the context of this specification, the types of images are not particularly limited. In addition, the image may be any suitable image, such as an original image obtained by an imaging device, or an image obtained from the original image based on specific processing on, such as preliminary filtering, de-aliasing, color adjustment, contrast adjustment, normalization, and the like. It should be noted that the image can also be preprocessed before pre-training/training/recognition, and the preprocessing operation can also include any other kind of preprocessing operation known in the art, which will not be described in detail here.

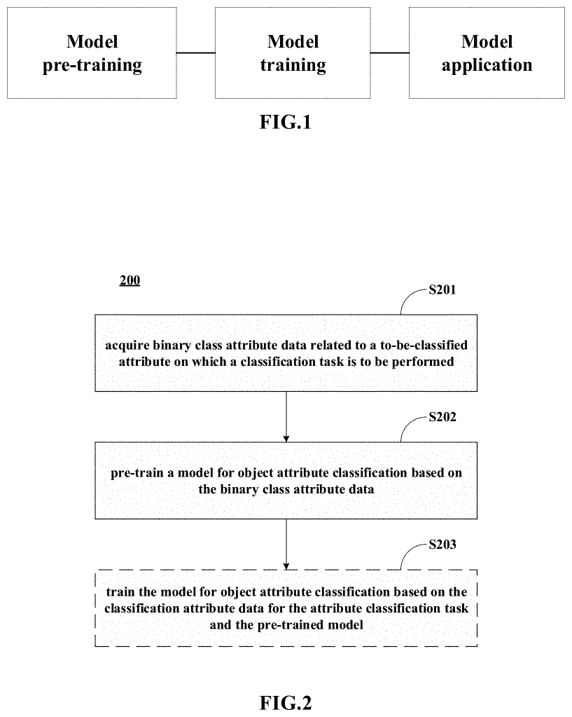

FIG. 2A illustrates a pre-training method of a model for object attribute classification according to an embodiment of the present disclosure. In the method 200, in step S201 (referred to as an acquisition step), binary class attribute data related to a to-be-classified attribute for an attribute classification task is acquired, and the binary class attribute data includes data indicating whether the to-be-classified attribute is “Yes” or “No” for each of at least one class label; and in step S202 (referred to as a pre-training step), pre-training of a model for object attribute classification is performed based on the binary class attribute data.

It should be noted that the to-be-classified attribute may refer to an attribute for which the attribute classification task is to carry out. For example, in the case of face attribute classification, such as eyebrow classification, eyebrow type can refer to the to-be-classified attribute. Other attributes in the face region, such as eyes, mouth, etc., can be referred to as other attributes.

According to an embodiment of the present disclosure, the meaning of the binary class attribute data can lie in directly indicating whether a certain class label of the attribute is “Yes” or “No”, so that the ambiguity is low, and the binary class attribute data can be easily collected, and thus can be acquired efficiently. It should be noted that the binary class attribute data can be in various suitable forms/values. For example, it can be “0” or “1” for each class, where “1” means that the attribute belongs to the class, “0” means that the attribute does not belong to the class, and vice versa. Of course, the binary class data can also be any two different values, one of which indicates “Yes” and the other indicates “No”.

According to an embodiment of the present disclosure, the binary class attribute data may include at least one data corresponding to at least one class label one by one, and each data indicates whether the to-be-classified attribute is “Yes” or “No” for a corresponding one of the at least one class label. Particularly, the binary class attribute data related to the attribute can be in the form of a set, a vector or the like containing more than one values, wherein each value corresponds to a class label and indicates whether the attribute is “Yes” or “No” for the class. In this way, compared with the existing multi-class attribute data which usually only indicates that the attribute belongs to one of the classes, the binary class attribute data can cover various combinations of more than one classes, especially when the attribute belongs to multiple classes, and can obtain more comprehensive attribute classification data. Taking eyebrow type attribute as an example, the class labels of eyebrow type may include heavy eyebrow and arched eyebrow, and the binary class attribute data for the eyebrow type attribute includes data indicating whether the eyebrow type is heavy eyebrow or not and data indicating whether the eyebrow type is arched eyebrow or not. In this way, the acquired binary class attribute data for eyebrow type attribute can cover a case that the eyebrow type attribute is both heavy eyebrow and arched eyebrow.

According to some embodiments, at least one class label and/or the number of labels corresponding to a binary class attribute data can be appropriately set. As an example, the number of such class labels can be smaller or even significantly smaller than the number of class labels specified in the attribute classification task, so that the amount of data to be collected is small, and the binary class attribute data can be obtained quickly and efficiently. In some embodiments, the class labels corresponding to a binary class attribute data may belong to rough class labels, and/or may have high distinguishability thereamong, so that the class labels can be easily distinguished from each other, for example, they may be easily judged and marked. Specifically, in some embodiments, the class labels corresponding to the binary class attribute data can be selected from representative categories of attributes, especially different categories of the object attribute exhibiting low relevance therebetween. Taking eyebrow attribute as an example, the categories of eyebrow attribute may include dense degree and shape of eyebrow, where dense degree category may include class labels such as heavy eyebrow and sparse eyebrow, etc., and shape category can include shape class labels such as monobrow and arched eyebrow, etc., so the class labels can be selected from these different aspects respectively, and the number of class labels can be appropriately set. For example, the class labels for the binary class attribute data can be selected from these two categories respectively, for example, one or more class labels can be selected from each category. In this way, through appropriate combination of class label data corresponding to different categories, data with more comprehensive attribute division can be obtained, thus further improving the accuracy of model training. Especially, when the class labels come from different categories and the number of class labels is small, the binary class attribute data can be obtained quickly and efficiently, and the combination of the obtained data can cover more comprehensive situations, thus further improving the accuracy of model training.

According to embodiments of the present disclosure, the class labels involved in the attribute classification task may belong to fine class labels, and/or there may have low distinguishability thereamong, for example, it is usually difficult to distinguish the labels from each other, and may be ambiguous when the labels are being judged/marked. For example, the class labels may include a plurality of labels with low distinguishability selected from object attributes of the same category.

According to embodiments of the present disclosure, the class label corresponding to the binary class attribute data may be included in and/or may not be included in class labels involved in the attribute classification task. In particular, the class labels corresponding to the binary class attribute data can all be included in the class labels for the attribute classification task, but the number is much smaller; or can be totally different from the class labels for the attribute classification task; or one part thereof is inside the class labels for the attribute classification task, while the other part is outside the class labels for the attribute classification task. As an example, for eyebrow classification, its binary class attribute data can indicate whether an eyebrow belongs to a certain eyebrow class, which may be included in or out of several eyebrow classes involved in the eyebrow classification task to be performed.

According to embodiments of the present disclosure, the binary class attribute data is related to the to-be-classified attribute, which may include not only the binary class attribute data of the to-be-classified attribute per se, but also the binary class attribute data of additional attributes associated with the to-be-classified attribute. In this case, the binary class attribute data may include data corresponding to more than one kind of attributes, usually each attribute has its own binary class attribute data, and the binary class attribute data of each attribute indicates whether the attribute is “Yes” or “No” for the respective related class, and can be expressed in a similar manner as the binary class attribute data of the to-be-classified attribute as described above. In this case, the binary class attribute data can be in various appropriate forms, especially in the form of data set/data vector, where each value in the set indicates whether a certain attribute is a certain class or not. Or it can be in the form of a matrix, in which rows and columns indicate the attributes and “Yes” or “No” of the class labels corresponding to the attributes, respectively. The associated attribute data are used together for pre-training, which can make the trained attribute classification performance to pay more attention to associated image regions and reduce the detail loss caused by global features.

According to other embodiments, other associated attributes can be determined in various appropriate ways, for example, they can be decided by proximity or semantic similarity between attributes.

In some embodiments, attributes being similar semantically means that the attributes have strong relevance and close relationship, for example, they can jointly constitute a feature representing an object. For example, in the case where the object is a human face and the to-be-classified attribute is an eyebrow type, the attributes which are semantically similar with the eyebrow type can include attributes that can be used to characterize the human face and usually be recognized together with the eyebrows, for example, face parts near the eyebrows, such as eyes, eye bags, and so on. The conditions regarding semantic similarity between attributes, for example, indicating which features can be considered as being semantically similar therebetween, can be set appropriately, for example, it can be set by the user empirically, or it can be set depending on the feature distribution characteristics of the object to be recognized, which will not be described in detail here.

In some embodiments, the proximity between attributes can be characterized by, for example, the distance between attributes. In particular, if the distance between attributes is less than or equal to a certain threshold, attributes can be considered to be proximate, and then they can be considered to be correlated. As an example, an associated additional attribute may be an additional attribute included in the image including the to-be-classified attribute which are proximate to the to-be-classified attribute, such as an additional attribute included in an image region proximate to the image region of the to-be-classified attribute. Taking eyebrow type as an example, there exists an additional attribute, such as eye attribute, in the image region proximate to the eyebrows, the eye attribute can be used as the additional attribute to obtain binary class data. The binary attribute data of proximate attributes are used for pre-training, which can make a convolutional neural network to pay more attention to the whole region, and reduce the detail loss caused by global features.

In yet some embodiments, both semantic similarity and distance between attributes can be considered. Especially, for the to-be-classified attribute, an additional attribute which is semantically similar with the to-be-classified attribute and has a distance from the to-be-classified attribute which is less than or equal to a specific threshold can be regarded as an associated attribute, and their binary class attribute data can be acquired for pre-training.

According to some embodiments, the binary class attribute data may be set/acquired for an image. For example, when a training sample set for image attribute classification is created, for each training sample image, the binary class attribute data of a to-be-classified attribute in the image can be acquired, and optionally, the binary class attribute data of an additional attribute associated with the to-be-classified attribute in the image can be obtained. Particularly, for an image, one or more attributes included in a region in the image corresponding to an attribute classification task, which may include the region of to-be-classified attribute, and additionally the region of a proximate attribute, are acquired. For example, when the eyebrow type in the face image is the to-be-classified attribute in the image classification task, the binary class data of the eyebrow type included in eyebrow region in the image can be acquired, and the binary class attribute data of the attribute in a region proximate to the eyebrow region, such as eyes or a part of eyes, can be further acquired.

According to embodiments of the present disclosure, the binary class attribute data can be acquired in various ways. According to some embodiments of the present disclosure, the binary class attribute data can be obtained by annotating training pictures, or be selected from a predetermined database. Acquisition of binary class attribute data according to an embodiment of the present disclosure will be described below.

Taking eyebrow classification as an example, it is assumed that the classification task is a six-class classification task comprising no eyebrow, S-shaped eyebrow, straight eyebrow, curved eyebrow, broken eyebrow, and sparse eyebrow. First, it is necessary to obtain the binary class data of various attributes in a region corresponding to the face attribute classification task, such as the binary class data of eyebrow region and the binary class data of eye attribute proximate to the eyebrow region. The binary class attribute data means that the label of the attribute is “Yes” or “No”, so the ambiguity is relatively low, and it is easier to collect the data. There are two ways to collect the binary class attribute data:

Collect/acquire from a public data set: currently, there are binary class data sets for face attribute classification, including Celeba and MAAD data sets. etc. Celeba data set contains 40 binary class labels for face attributes, including binary class label data indicating whether heavy eyebrow or not, whether arched eyebrow or not, whether small eye or not, whether eye bag or not, whether wearing glasses or not, and so on. MAAD data set contains 47 binary class labels for face attributes, including binary class label data indicating whether heavy eyebrow or not, whether arched eyebrow or not, whether brown eye or not, whether eye bag or not, whether wearing glasses or not, and so on. Therefore, some binary class data of the corresponding attribute regions can be obtained simply and conveniently.

Manual annotating: in a manner of annotating by an annotator. That is to say, for a picture, especially an attribute included in the picture, the annotator annotates its class. In embodiments of the present disclosure, the annotator is asked to perform binary class annotation to quickly obtain the pre-training data. For example, the binary class annotation is to only judge whether there exists arched eyebrow in the face picture or not. In this way, the annotator only needs to judge “Yes” or “No”, which is faster and has lower error rate.

According to an embodiment of the present disclosure, in the attribute classification model training, the binary class attribute data can be associated with a set of images or image regions to be used for training in an appropriate manner, for example, as annotation data, auxiliary information, etc., to indicate the classification status of attributes in the image or image region, and can be used as training samples. As an example, the input of the model is a complete face image, and the attribute classification task region in the collected face image has corresponding binary class attribute labels, so the network pre-training can be carried out by using the image and corresponding labels, so as to provide a good pre-trained model for subsequent formal attribute multi-classification task.

According to some embodiments of the present disclosure, the pre-training step includes training, based on the binary class attribute data, a pre-trained model that can perform object attribute classification with respect to the attribute class corresponding to the binary class attribute data. In particular, training is carried out based on the collected binary class data set, so that the obtained model is directed to the classification for binary class attribute data.

It should be noted that the pre-trained model can be any suitable type of model, including, for example, commonly used object recognition model, attribute classification model, etc., such as neural network models, deep learning models, etc. According to some embodiments of the present disclosure, the pre-trained model may be based on a convolutional neural network, and may sequentially include a feature extraction model constituted by a convolutional neural network, a fully connected layer, and binary class attribute classifiers. The fully connected layer can adopt various types known in the art, the binary class attribute classifiers correspond to the class labels of the binary class attribute data one by one, especially including the class labels of the attributes to be classified per se and associated additional attributes, and one classifier corresponds to one attribute class label.

According to embodiments of the present disclosure, the pre-training process can be performed in an appropriate manner. For example, the object attribute features can be extracted from each training sample/training picture in the training sample set, and can be used for per-training of model in conjunction with the binary class attribute data of the attributes acquired for each training sample. The object attribute feature can be represented in any suitable form, such as in a vector form, and the pre-training process can be performed in various suitable ways in the field, and for example, the training can be performed based on the extracted features and the binary class attribute data by using a loss function, so as to optimize the weights for parameters of the model. Specifically, after feature extraction and down-sampling, a feature matrix is obtained, and then the feature matrix is used for feature classification via a fully connected layer, and the classification is trained by calculating the loss. In particular, the loss calculation means calculating the loss based on the feature vector after feature extraction and the binary class attribute data, for example, calculating the loss by comparing the feature vector after feature extraction with the binary class attribute data. The loss can be calculated in various appropriate ways, such as cross entropy loss. The pre-training process can also be carried out in other appropriate ways, which will not be described in detail here.

Therefore, according to embodiments of the present disclosure, the binary class attribute picture and label data can be efficiently acquired for model pre-training, and an effective pre-trained model can be acquired and can be used as a good initial weight value, so that a better attribute classification model can be obtained on the basis of the pre-trained model to better complete the attribute classification task. In particular, the high efficiency is manifested in faster collection of attribute binary class data, less ambiguity and larger amount of data, and efficient acquisition of an effective pre-trained model.

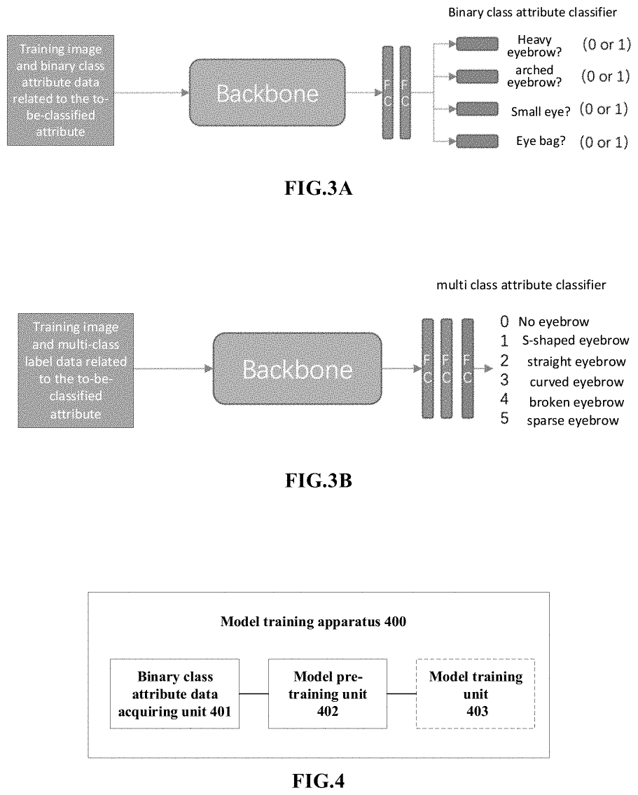

FIG. 3A illustrates an exemplary training process of a pre-trained model according to an embodiment of the present disclosure.

The pre-trained model can have a model architecture known in the art, such as a hierarchical model architecture, for example, the model consists of a basic neural network model Backbone and a fully connected layer FC, wherein Backbone and FC can be classical modules that have been proposed at present, without being obviously limited. In the pre-training stage, the pre-trained model can adopt Backbone+FC, and the last layer corresponds to a plurality of binary class attribute classifiers, which may be somewhat distinct from the final eyebrow classification model. It should be noted that at this time, each classifier corresponds to an acquired binary class of an image, and is not necessarily the final classification model.

The input is a training sample set, which comprises images containing object attributes and corresponding binary class attribute data. In this way, the collected binary class attributes can be utilized for model pre-training. As an example, for each picture in the model training data set, the binary class data for respective attributes in image regions in each picture containing the to-be-classified attribute can be labeled or acquired, and then serve as the input for the model training. In the pre-training stage, the final output of the model is a plurality of attribute binary classes, and the classification is trained by means of cross entropy loss. After the training, an efficient pre-trained model can be obtained and can be used for the final eyebrow classification task.

According to some embodiments of the present disclosure, it is also proposed to train a model for object attribute classification based on classification attribute data related to class labels involved in the attribute classification task and a pre-trained model obtained by the pre-training, as shown in step S203 in FIG. 2. It should be noted that step S203 is shown with a dashed line to indicate that the model training step is optional, and even if this step is not included, the concept of the pre-training method of the present disclosure is complete, and the aforementioned advantageous technical effects can be achieved.

According to some embodiments of the present disclosure, the classification attribute data corresponds to multi-class label data of object attributes. It should be pointed out that the classification attribute data here is different from the binary class attribute data as mentioned above, and can be multi-class attribute data. For example, for eyebrow attribute, one of more than two different values can be used to indicate a different eyebrow type, instead of just indicating “Yes” or “No” as mentioned above. As an example, the input data is a face image which contains eyebrows to be classified, and the classification task is for no eyebrow, S-shaped eyebrows, straight eyebrows, curved eyebrows, broken eyebrows, and sparse eyebrows. Assuming that the labels are 0, 1, 2, 3, 4, and 5 respectively corresponding to the classification task, the multi-class attribute data, if annotated by labels, can be presented by any digital in the above labels.

According to some embodiments of the present disclosure, the infrastructure of the training model may be basically consistent with that of the pre-trained model, including, for example, a convolutional neural network model and a following multi-class fully connected layer. Here, the convolutional neural network model can be the same as the model contained in the pre-trained model, and the multi-class fully connected layer corresponds to the multi-class label data, can be different from the connection layer of the pre-trained model or can be appropriately adjusted therefrom.

According to embodiments of the present disclosure, after the pre-trained model is obtained as described above, full training or fine-tuning can be performed for the attribute classification task based on the obtained pre-trained model, especially the fine-tuning or full training can be performed with the parameters of the neural network and the fully connected layer obtained in the pre-training stage as initial values. Full training or fine-tuning training can be carried out in various appropriate ways. In some embodiments, full training refers to taking all data with multi-class labels as the training sample set and inputting them into the training model for training. In this case, the parameters of neural network and connection layer can be adjusted simultaneously. In another embodiment, the fine-tuning is to load the binary class attribute data as the pre-trained model for fine-tuning. In the process of fine-tuning, the parameters of the neural network usually are kept unchanged, and only the parameters of the fully connected layer are updated during training.

FIG. 3B illustrates an exemplary attribute classification training process according to an embodiment of the present disclosure. After obtaining the efficient pre-trained model as mentioned above, we can further train the model for the final face attribute task based on the pre-trained model. As shown in FIG. 3B, firstly, the pre-trained model Backbone and the corresponding fully connected layer are loaded, and the multiple binary class attribute classifiers in the last layer of the model is replaced by a multi-class FC layer, which is a multi-class FC layer corresponding to six eyebrow classes in the example. For example, using a small amount of existing label data of six classes: no eyebrow, S-shaped eyebrow, straight eyebrow, curved eyebrow, broken eyebrow, and sparse eyebrow as input data, and adopting the cross-entropy loss to carry out final model training or model fine-tuning. In this way, compared with a way of not using the pre-trained model and a way of using ImageNet pre-trained model, the final result can obtain a further improved classification model, which has higher classification accuracy and achieve better classification effect than the way of not using the pre-trained model and the way of using ImageNet. A great improvement can be achieved for the final attribute multi-classification task.

This disclosure mainly proposes an efficient attribute-based pre-training solution, which uses some binary class attribute data included in and/or proximate to a region corresponding to object attribute classification for model pre-training, the data being easy to obtain and has a corresponding public data set, even if manual annotation is adopted, annotating the binary class attribute data has relatively low cost and high speed, and the required pre-training data can be obtained quickly. And these binary class attribute data are used to pre-train the model. The efficient pre-training solution proposed in this disclosure based on the binary class object attributes can improve the accuracy of the final attribute classification results, for example, by 2-3%. Although the above description is mainly directed to face attributes, it should be understood that the basic idea of the present disclosure can be equivalently applied to other kinds of object attribute analysis/classification, and will not be described in detail here. The model trained according to the present disclosure can be applied to various application scenarios, such as face recognition, face detection, face retrieval, face clustering, face comparison and so on.

According to the embodiment of the present disclosure, the invention also discloses an object attribute classification method comprising steps of acquiring a model for object attribute classification according to the method as mentioned above; and performing attribute classification on objects in an image to be processed by adopting the model. Especially, as mentioned above, the model trained by the present disclosure can achieve higher classification accuracy, so that the object attribute classification based on the model can obtain better classification effect. The final attribute multi-classification task can be improved.

A training apparatus according to an embodiment of the present disclosure will be described below with reference to the accompanying drawings. FIG. 4 shows an apparatus of training a model for object attribute classification according to an embodiment of the present disclosure. The apparatus 400 includes a binary class attribute data acquisition unit 401 configured to acquire binary class attribute data related to a to-be-classified attribute on which a classification task is to be performed, wherein the binary class attribute data includes data indicating whether the to-be-classified attribute is “Yes” or “No” for each of at least one class label; a model pre-training unit 402 configured to pre-train the model for object attribute classification based on the binary class attribute data; and a model training unit 403 configured to train the model for object attribute classification based on the classification attribute data related to class labels involved in the attribute classification task and the pre-trained model obtained by pre-training. Wherein, the pre-training unit may be further configured to train a pre-trained model that can classify object attributes according to class labels corresponding to the binary class attribute data, based on the binary class attribute data.

It should be noted that the training unit 403 is shown with a dashed line to indicate that the training unit 403 can also be located outside the model training apparatus 400. For example, in this case, the apparatus 400 efficiently obtains the pre-trained model and provides it to other devices for further training, while the apparatus 400 can still achieve the advantageous effects of the present disclosure as described above.

It should be noted that each of the above units only belongs to a logical module classified according to the specific function it implements, instead of limiting its specific implementation manner, for example, it can be implemented in software, hardware, or a combination of software and hardware. In an actual implementation, the foregoing units may be implemented as independent physical entities, or may be implemented by a single entity (for example, a processor (CPU or DSP, etc.), an integrated circuit, etc.). Furthermore, that the foregoing units are indicated by dotted lines in the figure indicates that the foregoing units may not actually exist, and the operation/functionality they achieve can be implemented by the processing circuit itself.

Furthermore, optionally, the apparatus may further include a memory which may store various kinds of information generated by the apparatus, respective units included in the apparatus in operation, programs and data used for operation, data to be transmitted via a communication unit, and so on. The memory may be a volatile memory and/or a non-volatile memory, for example, the memory may include, but not limited to, random access memory (RAM), dynamic random-access memory (DRAM), static random-access memory (SRAM), read-only memory (ROM), and flash memory. Of course, the memory can be located outside of the apparatus. Optionally, although not shown, the apparatus may also include a communication unit, which may be used to communicate with other devices. In an example, the communication unit may be implemented in an appropriate manner known in the art, for example, including communication components such as antenna arrays and/or radio frequency links, various types of interfaces, communication units, and the like, which will not be described in detail here. In addition, the apparatus may further include other components not shown, such as a radio frequency link, a baseband processing unit, a network interface, a processor, a controller, and the like, which will not be described detailedly here.

Some embodiments of the present disclosure also provide an electronic device operable to implement the operations/functions of the aforementioned model pre-training apparatus and/or model training apparatus. FIG. 5 shows a block diagram of some embodiments of the electronic device of the present disclosure. For example, in some embodiments, the electronic device 5 may be various types of devices, including but not limited to mobile terminals such as mobile phones, notebook computers, digital broadcast receivers, PDA (Personal Digital Assistant), PAD (Tablet PC), PMP (Portable Multimedia Player), vehicle-mounted terminals (such as vehicle-mounted navigation terminals), and fixed terminals such as digital TV, desktop computers, and the like. For example, the electronic device 5 may include a display panel for displaying data utilized in and/or execution results obtained by the solution according to the present disclosure. For example, the display panel may have various shapes, such as a rectangular panel, an oval panel, a polygonal panel, and the like. In addition, the display panel can be not only a flat panel, but also a curved panel or even a spherical panel.

As shown in FIG. 5, the electronic device 5 of this embodiment includes a memory 51 and a processor 52 coupled to the memory 51. It should be noted that the components of the electronic device 50 shown in FIG. 5 are only exemplary, not restrictive, and the electronic device 50 may also have other components according to practical application requirements. The processor 52 may control other components in the electronic device 5 to perform desired functions.

In some embodiments, the memory 51 can be used to store one or more computer-readable instructions. When the processor 52 is used to execute computer readable instructions, the computer readable instructions, when executed by the processor 52, implement the method according to any one of the above embodiments. Specific implementation of each step of the method and related explanations can refer to the above embodiments, and the repetition is not repeated here.

For example, the processor 52 and the memory 51 can communicate with each other directly or indirectly. For example, the processor 52 and the memory 51 may communicate through a network. The network may include a wireless network, a wired network, and/or any combination of wireless and wired networks. The processor 52 and the memory 51 can also communicate with each other through the system bus, which is not limited by this disclosure.

For example, the processor 52 can be embodied as various suitable processors and processing devices, such as a central processing unit (CPU), a Graphics Processing Unit (GPU), a network processor (NP), etc.; can also be a digital signal processor (DSP), an application specific integrated circuit (ASIC), a field programmable gate array (FPGA) or other programmable logic devices, discrete gate or transistor logic devices, and discrete hardware components. A central processing unit (CPU) can be X86 or ARM architecture. For example, the memory 51 may include any combination of various types of computer-readable storage media, such as volatile memory and/or nonvolatile memory. The memory 51 may include, for example, a system memory which stores, for example, an operating system, an application program, a Boot Loader, a database, other programs and so on. The storage medium can also store various applications and various data, etc. therein.

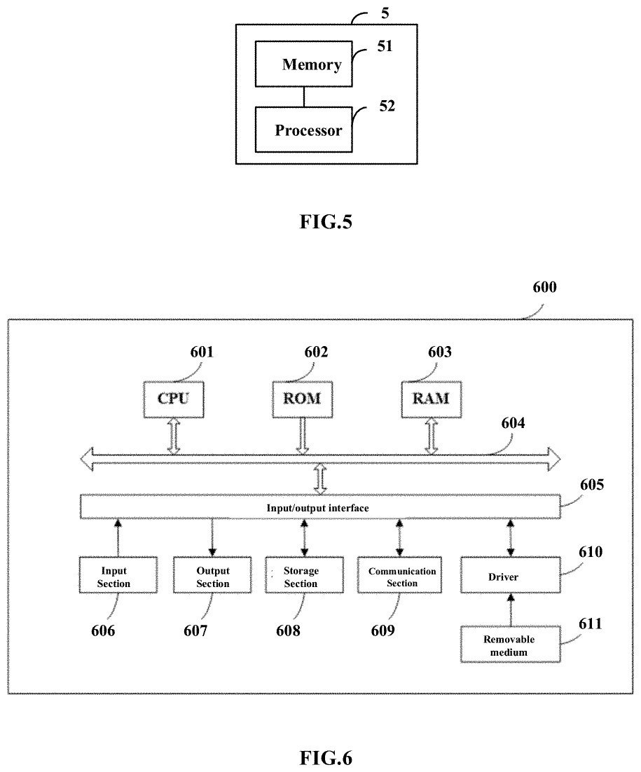

In addition, according to some embodiments of the present disclosure, when various operations/processes according to the present disclosure are implemented by software and/or firmware, programs constituting the software can be loaded from a storage medium or a network to a computer system having a dedicated hardware structure, such as the computer system 600 shown in FIG. 6, which, when various programs are installed thereon, can perform various functions including functions such as those described above. FIG. 6 is a block diagram showing an example structure of a computer system that can be employed in an embodiment of the present disclosure.

In FIG. 6, a central processing unit (CPU) 601 executes various processes according to programs stored in a read only memory (ROM) 602 or programs loaded from a storage section 608 into a random-access memory (RAM) 603. In the RAM 603, data required when the CPU 601 executes various processes and the like is also stored as required. The central processing unit is only exemplary, and it can also be other types of processors, such as the various processors described above. ROM 602, RAM 603, and storage section 608 may be various forms of computer-readable storage media, as described below. It should be noted that although the ROM 602, the RAM 603, and the storage device 608 are shown in FIG. 6, one or more of them may be incorporated or located in the same or different memories or storage modules.

A CPU 601, a ROM 602, and a RAM 603 are connected to each other via a bus 604. An input/output interface 605 is also connected to the bus 604.

The following components are connected to the input/output interface 605: an input portion 606 such as a touch screen, a touch pad, a keyboard, a mouse, an image sensor, a microphone, an accelerometer, a gyroscope, and the like; an output section 607 including a display such as a cathode ray tube (CRT), a liquid crystal display (LCD), a speaker, a vibrator, and the like; a storage portion 608 including a hard disk, a magnetic tape, and the like; and a communication section 609 including a network interface card such as a LAN card, a modem, and the like. The communication section 609 allows communication processing to be performed via a network such as the Internet. It is easy to understand that although each apparatus or module in the electronic device 600 is shown in FIG. 6 to communicate through the bus 604, they can also communicate through a network or other means, wherein the network can include a wireless network, a wired network, and/or any combination of wireless networks and wired networks.

A driver 610 is also connected to the input/output interface 605 as required. A removable medium 611 such as a magnetic disk, an optical disk, a magneto-optical disk, a semiconductor memory, etc. is installed on the drive 610 as required, so that a computer program read therefrom is installed into the storage section 608 as required.

In a case where the above series of processes are realized by software, a program constituting the software may be installed from a network such as the Internet or a storage medium such as the removable medium 611.

According to embodiments of the present disclosure, the process described above with reference to the flowchart may be implemented as a computer software program. For example, embodiments of the present disclosure include a computer program product including a computer program carried on a computer readable medium, the computer program containing program code for executing a method according to embodiments of the present disclosure. In such an embodiment, the computer program can be downloaded and installed from the network through the communication device 609, or installed from the storage device 608 or from the ROM 602. When the computer program is executed by the CPU 601, the above functions defined in the method of the embodiment of the present disclosure are executed.

It should be noted that in the context of the present disclosure, a computer-readable medium may be a tangible medium, which may contain or store a program for use by or in connection with an instruction execution system, apparatus, or device. The computer-readable medium can be a computer-readable signal medium or a computer-readable storage medium or any combination of the two. The computer-readable storage medium can be, for example, but not limited to, an electrical, magnetic, optical, electromagnetic, infrared, or semiconductor system, device, or device, or any combination of the above. More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, a computer-readable storage medium can be any tangible medium containing or storing a program, which can be used by or in connection with an instruction execution system, apparatus, or device. In this disclosure, the computer-readable signal medium may include a data signal propagated in baseband or as a part of a carrier wave, in which the computer-readable program code is carried. This propagated data signal can take various forms, including but not limited to electromagnetic signals, optical signals, or any suitable combination of the above. A computer-readable signal medium can also be any computer-readable medium other than a computer-readable storage medium, which can send, propagate, or transmit a program for use by or in connection with an instruction execution system, apparatus, or device. The program code included on the computer-readable medium can be transmitted by any suitable medium, including but not limited to electric wires, optical cables, RF (Radio Frequency), etc., or any suitable combination of the above.

The computer readable medium may be included in the electronic device; or it may exist alone and not be assembled into the electronic device.

In some embodiments, there is also provided a computer program comprising instructions that, when executed by a processor, cause the processor to perform the method of any one of the above embodiments. For example, the instructions may be embodied as computer program code.

In an embodiment of the present disclosure, computer program codes for performing the operations of the present disclosure may be written in one or more programming languages or a combination thereof, including but not limited to object-oriented programming languages such as Java, Smalltalk, C++, and conventional procedural programming languages such as “C” language or similar programming languages. The program code can be completely executed on the user computer, partially executed on the user computer, executed as an independent software package, partially executed on the user computer, partially executed on a remote computer, or completely executed on a remote computer or server. In a case involving a remote computer, the remote computer may be connected to a user computer through any kind of network (including a local area network (LAN) or a wide area network (WAN)), or may be connected to an external computer (for example, connected through the Internet using an Internet service provider).

The flowcharts and block diagrams in the figures illustrate the architecture, functions, and operations of possible implementations of systems, methods, and computer program products according to various embodiments of the present disclosure. In this regard, each block in the flowchart or block diagram may represent a module, a program segment, or a part of code containing one or more executable instructions for implementing specified logical functions. It should also be noted that in some alternative implementations, the functions noted in the blocks may also occur in a different order from those noted in the drawings. For example, two blocks represented in succession may actually be executed in substantially parallel, or they may sometimes be executed in reverse order, depending on the functions involved. It should also be noted that each block in the block diagrams and/or flowcharts, and combinations of blocks in the block diagrams and/or flowcharts, can be implemented with dedicated hardware-based systems that perform specified functions or operations, or can be implemented with combinations of dedicated hardware and computer instructions.

The modules, components or units described in the embodiments of this disclosure can be implemented by software or hardware. Among them, the name of a module, component or unit does not constitute the definition of the module, component, or unit itself under certain circumstances.

The functions described above herein may be performed at least in part by one or more hardware logic components. For example, without limitation, exemplary hardware logic components that can be used include field programmable gate array (FPGA), application specific integrated circuit (ASIC), application specific standard product (ASSP), system on chip (SOC), complex programmable logic device (CPLD), etc.

According to some embodiments of the present disclosure, there is provided a method of training a model for object attribute classification, comprising steps of: acquiring binary class attribute data related to a to-be-classified attribute on which an attribute classification task is to be performed, wherein the binary class attribute data includes data indicating whether the to-be-classified attribute is “Yes” or “No” for each of at least one class label; and pre-training the model for object attribute classification based on the binary class attribute data.

In some embodiments, the binary class attribute data comprises at least one value corresponding to the at least one class label one by one, each value indicating whether the to-be-classified attribute is “Yes” or “No” for one of the at least one class label.

In some embodiments, the at least one class label comprises class labels selected from different categories related to the to-be-classified attribute.

In some embodiments, the at least one class label is different from or at least partially overlaps with class labels involved in the attribute classification task.

In some embodiments, the at least one class label comprises class labels of coarse classes which are greatly different from each other.

In some embodiments, the class labels involved in the attribute classification task include class labels of fine class.

In some embodiments, the binary class attribute data further comprises binary class attribute data of at least one additional attribute associated with the to-be-classified attribute, wherein the binary class attribute data of each additional attribute in the at least one additional attribute indicates whether the additional attribute is “Yes” or “No” for respective related class.

In some embodiments, the additional attribute associated with the to-be-classified attribute includes an additional attribute which is semantically similar with the to-be-classified attribute.

In some embodiments, the additional attribute associated with the to-be-classified attribute includes an additional attribute whose distance from the to-be-classified attribute is less than or equal to a specific threshold.

In some embodiments, the additional attribute associated with the to-be-classified attribute includes an additional attribute acquired from an image region of the to-be-classified attribute and/or at least one additional image region proximate to the image region of the to-be-classified attribute.

In some embodiments, the binary class attribute data is obtained by annotating training pictures, or is selected from a predetermined database.

In some embodiments, the pre-training step comprises training a pre-trained model, which is capable of classifying the object attribute according to class labels corresponding to the binary class attribute data, based on the binary class attribute data.

In some embodiments, the pre-trained model comprises a convolutional neural network model, a fully connected layer and binary class attribute classifiers corresponding to the class labels of the binary class attribute data one by one which are arranged sequentially.

In some embodiments, the method further comprises training the model for object attribute classification based on the class label data for the attribute classification task and the pre-trained model.

In some embodiments, the trained model comprises a convolutional neural network model and a multi-class fully connected layer corresponding to the class labels for the attribute classification task which are arranged sequentially.

According to some embodiments of the present disclosure, there is provided an apparatus of training a model for object attribute classification, comprising a binary class attribute data acquiring unit configured to acquire binary class attribute data related to a to-be-classified attribute on which an attribute classification task is to be performed, wherein the binary class attribute data includes data indicating whether the to-be-classified attribute is “Yes” or “No” for each of at least one class label; and a pre-training unit configured to pre-train the model for object attribute classification based on the binary class attribute data.

In some embodiments, the training apparatus further comprises a model training unit configured to train the model for object attribute classification based on class label data for the attribute classification task and the pre-trained model.

According to still further embodiments of the present disclosure, there is provided an electronic device including a memory; and a processor coupled to the memory, wherein instructions are stored in the memory, and the instructions, when executed by the processor, cause the electronic device to perform the method of any embodiment described in the present disclosure.

According to further embodiments of the present disclosure, there is provided a computer-readable storage medium having a computer program stored thereon, which, when executed by a processor, implements the method of any one of the embodiments described in the present disclosure.

According to further embodiments of the present disclosure, there is provided a computer program comprising instructions that, when executed by a processor, cause the processor to perform the method of any one of the embodiments described in the present disclosure.

According to some embodiments of the present disclosure, there is provided a computer program product comprising instructions that, when executed by a processor, implement the method of any one of the embodiments described in the present disclosure.

According to some embodiments of the present disclosure, there is provided a computer program or a computer program product comprising instructions, which, when executed by a computer, cause the computer to implement the method of any one of the embodiments described in the present disclosure.

The above description is only an explanation of some embodiments of the present disclosure and the applied technical principles. It should be understood by those skilled in the art that the present disclosure scope involved in this disclosure is not limited to the technical solution formed by the specific combination of the above technical features, but also encompasses other technical solutions formed by any combination of the above technical features or their equivalent features without departing from the above disclosure concept, for example, a technical solution formed by replacing the above features with the technical features with similar functions disclosed in this disclosure (but not limited to).

In the description provided herein, many specific details are set forth. However, it shall be understood that embodiments of the present invention may be practiced without these specific details. In other cases, well-known methods, structures, and techniques have not been shown in detail in order not to obscure the understanding of this description.

Furthermore, although the operations are depicted in a particular order, this should not be understood as requiring that the operations be performed in the particular order shown or performed in a sequential order. Under certain circumstances, multitasking and parallel processing may be advantageous. Likewise, although several specific implementation details are included in the above discussion, these should not be interpreted as limitations on the scope of the present disclosure. Certain features described in the context of separate embodiments may also be implemented in a single embodiment in combination. On the contrary, various features described in the context of a single embodiment can also be implemented in multiple embodiments individually or in any suitable sub-combination.

Although some specific embodiments of the present disclosure have been described in detail by examples, it should be understood by those skilled in the art that the above examples are for illustration only, and are not intended to limit the scope of the present disclosure. It should be understood by those skilled in the art that modifications can be made to the above embodiments without departing from the scope and spirit of the present disclosure. The scope of this disclosure is defined by the appended claims.

What is claimed is:

1. A method of training a model for object attribute classification, comprising steps of:
acquiring binary class attribute data related to a to-be-classified attribute on which an attribute classification task is to be performed, wherein the binary class attribute data includes data indicating whether the to-be-classified attribute is “Yes” or “No” for each of at least one class label; and
pre-training the model for object attribute classification based on the binary class attribute data.

2. The method of claim 1, wherein the binary class attribute data comprises at least one value corresponding to the at least one class label one by one, each value indicating whether the to-be-classified attribute is “Yes” or “No” for one of the at least one class label.

3. The method of claim 1, wherein the at least one class label comprises class labels selected from different categories related to the to-be-classified attribute.

4. The method of claim 1, wherein the at least one class label is different from or at least partially overlaps with class labels involved in the attribute classification task.

5. The method of claim 1, wherein the binary class attribute data further comprises binary class attribute data of at least one additional attribute associated with the to-be-classified attribute, wherein the binary class attribute data of each additional attribute in the at least one additional attribute indicates whether the additional attribute is “Yes” or “No” for respective related class.

6. The method of claim 5, wherein the additional attribute associated with the to-be-classified attribute includes an additional attribute which is semantically similar with the to-be-classified attribute.

7. The method of claim 6, wherein the additional attribute associated with the to-be-classified attribute includes an additional attribute whose distance from the to-be-classified attribute is less than or equal to a specific threshold.

8. The method of claim 5, wherein the additional attribute associated with the to-be-classified attribute includes an additional attribute acquired from an image region of the to-be-classified attribute and/or at least one additional image region proximate to the image region of the to-be-classified attribute.

9. The method of claim 1, wherein,
the binary class attribute data is obtained by annotating training pictures, or is selected from a predetermined database.

10. The method of claim 1, wherein the pre-training step comprises training a pre-trained model, which is capable of classifying the object attribute according to class labels corresponding to the binary class attribute data, based on the binary class attribute data.

11. The method of claim 10, wherein the pre-trained model comprises a convolutional neural network model, a fully connected layer and binary class attribute classifiers corresponding to the class labels of the binary class attribute data one by one which are arranged sequentially.

12. The method of claim 10, further comprising:
training the model for object attribute classification based on the class label data for the attribute classification task and the pre-trained model.

13. The method of claim 12, wherein the trained model comprises a convolutional neural network model and a multi-class fully connected layer corresponding to the class labels for the attribute classification task which are arranged sequentially.

14. The method of claim 1, wherein the at least one class label comprises class labels of coarse classes which are greatly different from each other.

15. The method of claim 1, wherein the class labels involved in the attribute classification task include class labels of fine class.

16. An apparatus of training a model for object attribute classification, comprising:
binary class attribute data acquiring unit configured to acquire binary class attribute data related to a to-be-classified attribute on which an attribute classification task is to be performed, wherein the binary class attribute data includes data indicating whether the to-be-classified attribute is “Yes” or “No” for each of at least one class label; and
model pre-training unit configured to pre-train the model for object attribute classification based on the binary class attribute data.

17. The apparatus of claim 16, further comprising:
model training unit configured to train the model for object attribute classification based on class label data for the attribute classification task and the pre-trained model.

18. An electronic device comprising:
a memory; and
a processor coupled to the memory, the memory having stored therein instructions that, when executed by the processor, cause the electronic device to perform the method of claim 1.
